(19) United States
(12) Patent Application Publication
(10) Pub. No.: US 2006/0193753 A1
(43) Pub. Date: Aug. 31, 2006

(54) System and method for cold specimen transport

(76) Inventor: Loren Redburn, Weymouth, MA (US)

Correspondence Address: BURNS & LEVINSON LLP, 1030 15TH STREET NW, SUITE 300, WASHINGTON, DC, 20005-1501, US

(21) Appl. No.: 11/364,474

(22) Filed: Feb. 28, 2006

Related U.S. Application Data
(60) Provisional application No. 60/657,343, filed on Feb. 28, 2005.

(51) Int. Cl. B01L 3/00

(52) U.S. Cl. 422/102

(57) ABSTRACT

A system and method for cooling, storing, and transporting specimens within a container, wherein the system includes a temperature control medium for maintaining the stored specimens at a desired temperature grade.

### CROSS REFERENCE TO RELATED APPLICATIONS

This application claims the priority under 35 U.S.C. § 119 of provisional application Ser. No. 60/657,343 entitled “Clinical Laboratory Specimen Temperature Control Pack”, filed Feb. 28, 2005 and which incorporated herein by reference.

### FIELD OF THE INVENTION

The present invention relates generally to the field of specimen storage and transport, and more particularly to the refrigeration and control of the temperature of specimens such as, but not limited to, blood.

### BACKGROUND OF THE INVENTION

Prior art solutions in the field of refrigeration are numerous and apply to many different applications. Some examples of the prior art include U.S. Pat. No. 4,049,408 to Patel, U.S. Pat. No. 4,343,158 to Campbell, U.S. Pat. No. 4,619,678 to Rubin, U.S. Pat. No. 5,361,603 to Merritt-Munson, U.S. Pat. No. 5,956,968 to Grabowski, and U.S. Pat. No. 6,067,803 to Wolsey et al. However, none of these prior art solutions operate to solve the problems addressed by the present invention.

In most cases, after drawing blood, a nurse must retrieve a bag for ice, walk to an ice machine that is often in another room and occasionally on another floor, fill the bag with ice, place a biohazard bag containing specimen into the ice bag, seal the ice bag so that it does not leak water, and then retrace her or his steps to the room in which the blood was drawn. This traditional method of specimen storage places an unnecessary additional burden on the nurse as well as subjects the specimens to hazards which nay be encountered during the above process.

The present device can be sent through a pneumatic tube system, whereas the traditional ice bag method of specimen storage creates significant bulk that prevents the specimen from passing through the pneumatic system. Another problem associated with current refrigeration techniques involve lab technicians who must open the ice bag over a sink while being careful in discarding the bag to prevent water spilling on the floor, dry their hands, then open the biohazard bag to retrieve the specimen.

A need therefore exists to overcome the problems encountered above and therefore provide a safe, efficient specimen storage unit or transporter which provides a temperature controlled environment for the storage of and transportation of specimens, such as, for example blood or the like.

A further need involves the provision of a specimen handling unit which eliminates the problems associated with melting ice, and therefore reduces problems associated with specimen handling in a temperature controlled environment.

### BRIEF SUMMARY OF THE INVENTION

The present invention addresses important unmet needs in temperature controlled specimen handling with a simple and ingenious solution. It improves quality, which is the single most important factor in clinical laboratory testing, by preserving specimen integrity for those tests that require cold specimens in order to give accurate test results. There are many tests, particularly in critical care settings that need blood to be kept between 2-8 degrees Celsius and avoid many opportunities in the specimen handling protocols for failure to meet that requirement. The cold specimen transport pack or unit (also referred to as specimen transporter) and associated method of the present invention will greatly improve practices in which cold temperature of the specimen must be maintained prior to testing.

Certain tests must be performed on blood specimens that cannot be allowed to warm because the analyte will substantially diminish in a way that cannot be compensated for in the analysis itself. These include, but are not limited to, blood gases, lactate, ammonia, Factors V and VIII, and cellular immunology. Many other tests benefit from being kept cool, in general. The cold specimen transporter will improve specimen quality at several of the preanalytic steps.

The specimens will immediately be brought to temperature rather than awaiting transfer to an ice bucket or carrying container. This will eliminate the serious errors that can be introduced when a specimen is collected and allowed to remain at ambient room temperature for any of many reasons, before being placed in a temperature controlled container. A secondary advantage of the system at this stage will be the elimination of possible specimen mix-ups by the immediate association of it in the back compartment and the associated requisition in the front compartment.

Within hospitals, the transport of collected specimens to the laboratory can be done by phlebotomists or transport staff couriers, or through pneumatic tube systems. In each case, but particularly the former, delays can occur that introduce uncorrectable errors in the test results because of prolonged time at ambient temperatures.

Once the specimens arrive in the laboratory, variable periods of time pass before they are logged in and delivered to the analytical work stations for testing. Such periods are often prolonged, especially during peak testing hours. The negative impact on the test results that this causes cannot be corrected. These lengthy time periods the risk that the specimens will return to ambient temperature before it is processed.

The concerns addressed above are equally applicable to monitoring the transport of the blood specimens from the facility where it was drawn to a remote laboratory location. Although most courier vehicles have large specimen coolers, the transit time between removal of specimens from the referring laboratory and placement in those coolers is an uncontrolled variable that places the specimens at risk.

More generally, the present invention includes a device for maintaining a desired temperature range for stored specimen, comprising a flexible container having an open end for receiving the specimen, said flexible container further comprising an exterior surface; a receptacle adjacent the exterior surface of the flexible container for storing a temperature control medium made up of separate agents which provides cooling when combined; and means for sealing the opening of said flexible container thereby storing the specimen within said flexible container.

For a better understanding of the present invention, together with other and further needs thereof, reference is made to the accompanying drawings and detailed description and its scope will be pointed out in the appended claims.

### BRIEF DESCRIPTION OF THE SEVERAL VIEWS OF THE DRAWING

FIG. 1 is a pictorial front view of the cold specimen transporter of the present invention;

FIG. 2 is a pictorial rear view of the cold specimen transporter of the present invention;

FIG. 3 is a pictorial front view of another embodiment of the cold specimen transporter of the present invention;

FIG. 4 is a pictorial front view of still another embodiment of the cold specimen transporter of the present invention; and

FIG. 5 is a pictorial front view of a further embodiment of the cold specimen transporter of the present invention.

### DETAILED DESCRIPTION OF THE INVENTION

The present invention comprises a specimen storage unit or specimen transport pack or transporter 10, all of these terms and similar terms being used throughout the specification and claims interchangeably, that is designed to provide temperature control for desired items or articles. Temperature control can include initial cooling, as well as maintaining a desired temperature for the items. The items or articles may comprise any type of container, substance, or combination that requires temperature control.

The present invention includes a temperature control medium and an article receiving portion. The temperature control medium may comprise any disposable type of material as is known in the art; such as the combination of ammonium nitrate and water, or that of urea and water or other such combinations of chemical agents which will provide the desired cooling of the specimens. An appendix is provided setting forth in more detail descriptions of such chemicals.

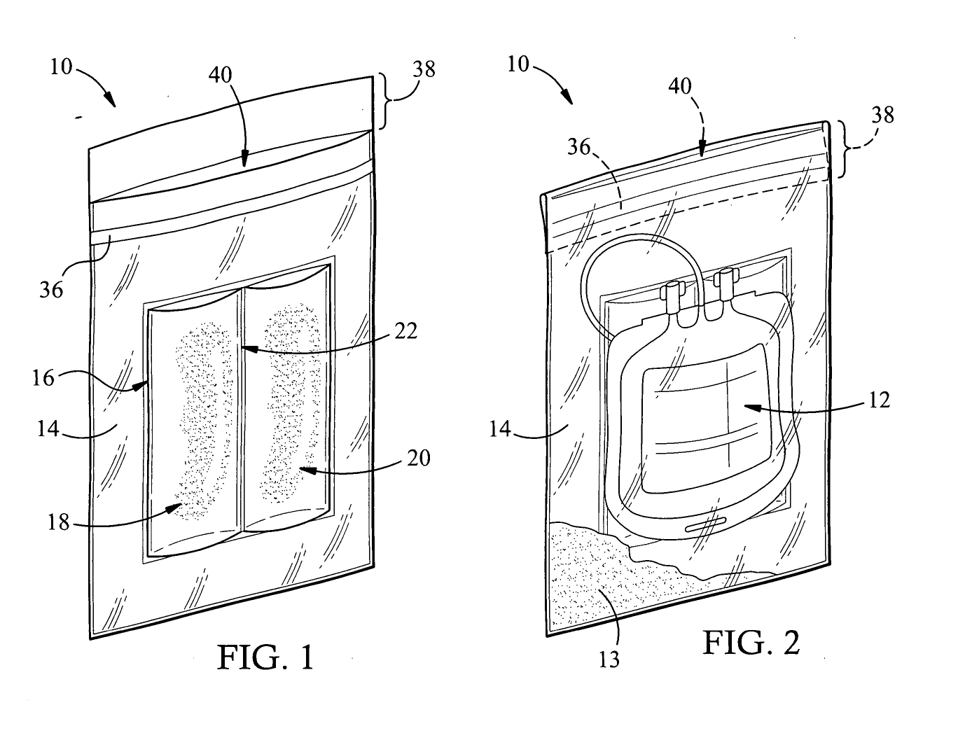

In one embodiment and with reference to FIG. 1, the specimens, such as blood, which are contained within their own sanitary pouch 12, are deposited within a transparent, water-tight, flexible, bag-like container 14 made of, for example, polyethylene or the like. A receptacle or pouch 16 is adhered to the outer surface of the bag-like container 14. The pouch or receptacle 16 is made of two compartments 18 and 20 separated by a frangible membrane 22 which contain sealed therein different agents such as water and ammonium nitrate or urea, respectively. A typical receptacle dimension may be approximately 7 inches in length and 6 inches in width. However, it should be realized that these dimensions are not limiting but merely provided to illustrate the general size of the overall unit.

When force is applied to receptacle 16, the frangible membrane is easily broken open, resulting in the mixture of the agents therein such as water and the ammonium nitrate or urea. The ensuing chemical reaction provides the desired cooling means. It should be realized for clarity that in further embodiments of this invention, similar or like components or elements may be given identical reference numerals throughout the specification.

FIG. 2 represents a rear view of the specimen storage unit 10 clearly illustrating the specimen pouch 12 as well as a removable or fixedly secured absorbent material 13 within the bag-like container 14. The absorbent material, which may be in the form of gauze or the like not only protects the specimen but would absorb a small amount a liquid if it escapes from pouch 12.

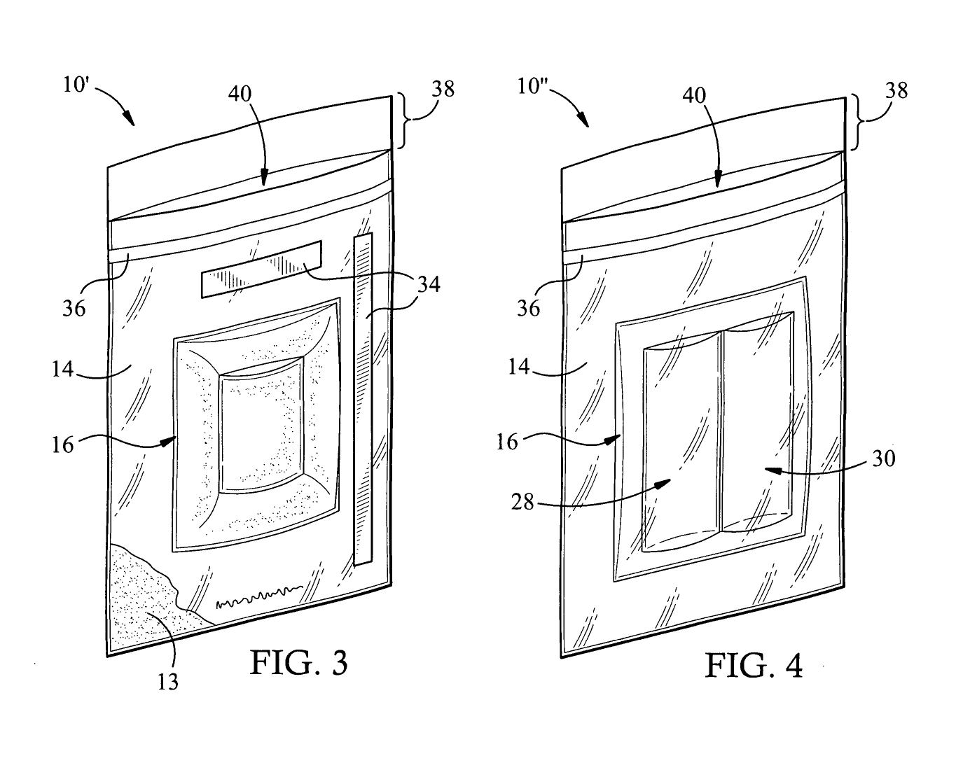

In a further embodiment of the invention as shown in FIG. 3, the specimen storage unit 10′ incorporates therein one chemical agent placed directly in receptacle 16 while another chemical agent, such as water, is placed in a separate sealed pouch 24 located within receptacle 16. Similarly to the embodiment depicted in FIG. 1, pouch 24 is easily broken open when force is applied, resulting in the mixture of the agents to produce the ensuing chemical reaction provides the desired cooling means.

A still further embodiment is shown in FIG. 4 illustrates specimen storage unit 10″ wherein a separate pouch 26 having separate compartments 28 and 30 with agents therein is sealed in receptacle 16.

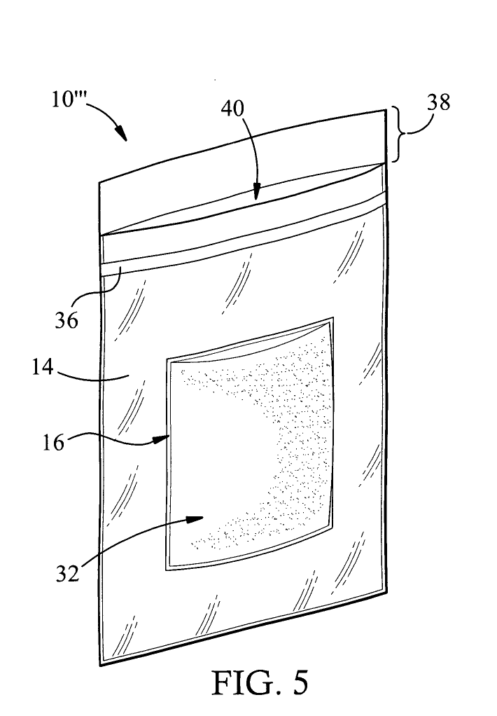

In an even further embodiment as shown in FIG. 5 a specimen storage unit 10′″ is provided. In this embodiment, the temperature control medium 32 may be of the reusable gel-type medium, as is known in the art located with receptacle 16. If this embodiment is implemented, the specimen storage unit 10′″ may be frozen in a freezer or the like and reused, and need not be disposed of after each use.

Referring now to the figures in general, the bag-like container 14 (also referred to as the receiving portion) of the present invention may comprise a substantially clear or transparent material, such as a substantially transparent polyethylene or the like. This bag-like flexible container may be approximately 10 inches in length and 6 inches in width. However, these dimensions are not to be considered limiting but only illustrative to show a typical size of the transporter or specimen storage unit 10 of the present invention. The size of the unit 10 varies depending upon the size of the specimens to be contained therein. It is desirous for the receiving portion to comprise a transparent material to allow for easy and quick identification of the items within. The items may be identified by the nature of the substance itself, or the container holding the substance may be identifiable by itself, or it may include a label that can be viewed for easy identification. A section of the receiving portion may be substantially transparent, or the entire receiving portion may be substantially transparent.

Where less than the entire receiving portion is substantially transparent, the transparent section should be located such that the item within may still be easily identified. The receiving portion may also include various indicia 34 including text, symbols, colors, and/or any combination of these for the display of instructions, hazards, warning or any other indicia required to be on devices used in the medical field, as applicable.

The receiving portion may also include a section 36 that is capable of receiving markings from a marking instrument, such as a pen, pencil, marker or other writing instrument. The receiving portion should also include at least a section, if not the entire receiving portion 14, that is capable of receiving adhesive labels that may be applied during the normal use of the present invention.

Structurally, the receiving portion 14 may share some portion of its exterior surface with a surface utilized by the receptacle 16 that contains the temperature control medium. Further, the receptacle may be affixed to the exterior surface of container 14 either permanently or releasably. The manner and sections of the receiving portion 14 that are attached to the receptacle 16 may vary; for example if the exterior surface is not shared with receptacle 16, edges of the receiving portion may be affixed to receptacle 16. Alternatively, the receiving portion 14 may be affixed to receptacle 16 via an adhesive, Velcro® style fasteners or the like.

The present invention also preferably includes a receiving portion seal 38. In one embodiment, the receiving portion seal 38 is effected by folding a top portion of the container 14 over an opening 40 of the receiving portion or container 14. This embodiment is inexpensive to manufacture and easy to use. In another embodiment, the receiving portion 14 of the present invention includes a sealing flap that may be folded over the opening of the receiving portion. In either embodiment the seal may be completed by means of any form of adhesive material, for example a strip of adhesive that includes a peel-away protective strip, a gum type adhesive, or any form of adhesive known in the art. The adhesive may be of the type that is releasable and re-sealable. Alternatively, the receiving portion seal may include any type of zip-style seal as is well known in the art.

In another embodiment, the seal may not be releasable or re-sealable. In this embodiment a receiving portion access may be provided. The receiving portion access may comprise a perforated section that is easily torn when necessary to retrieve the item within, yet sufficiently sealed to provide the necessary closure to protect the item within and ensure the appropriate temperature control.

As described above, the interior of the receiving portion 14 of the present invention may also include inserts 13. The inserts 13 may comprise an absorbent material in sufficient quantity and absorbency to combat any comprise in the received container's integrity. This feature may be mandated by government agencies and/or health care professionals, and is particularly useful when the substance includes liquid.

The cold transporter pack also includes an indicator 42 on the face of the receiving portion or container 14 for indicating when the desired temperature gradient has been breached, i.e. when the cold transporter pack 10 has warmed to room temperature.

The present invention also sets forth a method of controlling the temperature of a specimen by means of the aforementioned specimen storage unit 10. The method includes steps such as providing a temperature control medium, and activating it when necessary; inserting an item such as a blood specimen within a receiving portion; and sealing the receiving portion. Other steps include folding over the top portion of the receiving portion in one embodiment, or folding over the sealing flap of the receiving portion if so equipped, sealing the receiving portion, labeling the item or the receiving portion, providing warnings and or other indicia on the device, including the receiving portion area, maintaining the temperature of the item, providing absorbency capability within the receiving portion, disposing of the spent temperature control medium if of the disposable type, preparing the temperature control medium for a subsequent use if of the reusable type.

In a typical usage of the present invention, a nurse squeezes and shakes the bag to mix the coolant, and drops the specimen into the bag without having to leave the location where the blood was drawn. The transporter or specimen storage unit 10 is packaged so the product is always in close proximity to the patient or nursing stations. The transporter or specimen storage unit 10 is self contained so that no secondary ice bag is needed.

Although the present invention has been described with reference to particular embodiments, it will be apparent to those skilled in the art that variations and modifications can be substituted therefore without departing from the principles and spirit of the invention.

I claim:

1. A device for maintaining a desired temperature range for a stored specimen, comprising:
a flexible container having an open end for receiving the specimen, said flexible container further comprising an exterior surface;
a receptacle adjacent the exterior surface of the flexible container for storing a temperature control medium made up of separate agents which provides cooling when combined; and
means for sealing the opening of said flexible container thereby storing the specimen within said flexible container.

2. The device of claim 1, wherein said receptacle comprises a pair of compartments separated by a frangible membrane, each of said compartments containing one of said separate agents.

3. The device of claim 1, wherein said receptacle contains a pouch made of a pair of compartments separated by a frangible membrane, each of said compartments containing one of said separate agents.

4. The device of claim 1, wherein said receptacle contains one of said separate agents and a pouch made of a frangible material.

5. The device of claim 1, wherein said receptacle is releasably attached to said exterior surface of said flexible container.

6. A device for maintaining a desired temperature range for a stored specimen, comprising:
a flexible container having an interior portion and an open end for receiving the specimen into said interior portion, said flexible container further comprising an exterior surface;
a receptacle adjacent the exterior surface of the flexible container for storing a first temperature control agent and a second temperature control agent separated by a frangible membrane;
an absorbent material removably located within said interior portion of said flexible container; and
means for sealing the opening of said flexible container thereby storing the specimen within said interior portion of said flexible container.

7. The device of claim 6, wherein said first temperature control agent is water.

8. The device of claim 8, wherein the second temperature control agent is ammonium nitrate.

9. The device of claim 8, wherein the second temperature control agent is urea.

10. The device of claim 6, wherein said receptacle is releasably attached to said exterior surface of said flexible container.

11. A method of maintaining a desired temperature range for a stored specimen, comprising:
providing a first temperature control agent within a receptacle of a bag-like container for storing the specimen;
providing a second temperature control agent within the receptacle of a the bag-like container;
mixing the first agent and the second agent to activate a temperature control medium;
inserting a specimen within a receiving portion of the bag-like container; and
sealing the receiving portion to store and cool the specimen within the bag-like container.

12. The method of claim 11, wherein the first temperature control agent is water.

13. The method of claim 12, wherein the second temperature control agent is ammonium nitrate.

13. The method of claim 12, wherein the second temperature control agent is urea.

14. The device of claim 11, wherein the receptacle is releasably attached to the bag-like container.
